(19) United States
(12) Patent Application Publication
(10) Pub. No.: US 2019/0360855 A1
(43) Pub. Date: Nov. 28, 2019

(54) ON-BOARD WEIGHING SYSTEM

(71) Applicant: DEKKER INDUSTRIES PTY LTD, Davenport (AU)

(72) Inventors: Alexander DEKKER, North Boyanup (AU); Barry John DEKKER, Davenport (AU)

(73) Assignee: Dekker Industries Pty Ltd, Davenport (AU)

(21) Appl. No.: 15/754,962

(22) PCT Filed: Aug. 23, 2016
(86) PCT No.: PCT/AU2016/000287

§ 371 Date: Feb. 23, 2018

(30) Foreign Application Priority Data
Aug. 24, 2015 (AU) 2015903407
Feb. 23, 2016 (AU) 2016900637

(51) Int. Cl. G01G 19/12; F16C 11/04; B60G 7/00

(52) U.S. Cl. CPC G01G 19/12; F16C 11/045; B60G 7/008; F16C 2326/05; B60G 2300/042; B60G 2400/60; B60G 2202/112; B60G 2204/143; B60G 2204/41; B60G 2300/0262

(57) ABSTRACT

The invention relates to a suspension (20) in accordance with a first embodiment of the invention that permits reducing the number of load cells (14) incorporated in a suspension (20) of a vehicle or a trailer such as a semi-trailer to be towed by a towing vehicle. In accordance with a particular embodiment of the invention reduction of the number of load cells (14) is accomplished through the use of pivot joints (34) (that pivotally attach the suspension rockers (32) to the hangers 26) of reduced friction. In particular embodiments of the invention, the number and location of the low and lower friction pivot joints (34) may be chosen such as to increase the accuracy of measurement of the load cells. The invention also relates to load cell pins (62) for defining the pivot joint (34) that pivotally attaches rockers (32) to hangers (26) of the suspension (20).

### TECHNICAL FIELD

The present invention relates to onboard weighing systems.

The invention has been devised particularly, although not necessarily solely, in relation to on-board weighing systems for vehicles or semi-trailers.

### BACKGROUND ART

The following discussion of the background art is intended to facilitate an understanding of the present invention only. The discussion is not an acknowledgement or admission that any of the material referred to is or was part of the common general knowledge as at the priority date of the application.

FIG. 1 depicts a rear section 10 of a semi-trailer for loading and transporting of materials. The materials are loaded onto a tray 12 which is mounted onto a chassis of the semi-trailer.

The weight of the semi-trailer 10 increases as the material is loaded onto the tray 12. During the loading process it is necessary to measure the load that is being applied to the semi-trailer as materials are mounted onto the trailer. This is due to, for example, safety concerns and to maintain the integrity of the semi-trailer.

Measurement of the load applied to the semi-trailer may be conducted through onboard weighing systems. A particular onboard weighing system comprises a plurality of load cells 14. The load cells 14 are located at particular locations between the lower surface of the chassis of the semi-trailer and the suspension 16 of the semi-trailer 10. Each side of the chassis comprises a particularly number of load cells 14

In FIGS. 1, 35 and 36 there is shown a plurality of load cells 14 for measuring the load that is applied to the semi-trailer. In the arrangement of semi-trailer in accordance with the prior art there are four load cells 14 on each side of the semi-trailer 12.

As shown in FIG. 1, each load cell 14 is mounted on a hanger 18 of the suspension 16. In this manner the load cells 14 are sandwiched between the suspension 16 and the chassis. This allows detecting any variations of loads that are applied to the tray 12 during loading of materials onto the trailer 12 due to deformation such as compression of the load cells 14.

Load cells 14 are measurement devices that require periodical maintenance. Also, the load cells 14 due to being precision equipment may be relative expensive. Moreover, the load cells 14 need to be connected to devices that receive the signals emitted by the load cells 14. Thus, incorporating a relative large number of load cells 14 (as is the case currently of the conventional semi-trailers example of them being shown in FIGS. 1, 35 and 36) increases the costs for mounting and maintaining the onboard weighing systems comprising the load cells 14. Moreover, load cells 14 may be prone to malfunction and typically require periodical adjustment and calibration to ensure that proper values of the load are delivered to the devices that are electrically connected to the load cells 14 for processing and displaying the load that is being applied to the tray 12. Typically, adjustment and calibration of a relative large number of load cells is a cumbersome and expensive task.

It is against this background that the present invention has been developed.

### SUMMARY OF INVENTION

The present invention relates to suspensions that permit reducing the number of load cells incorporated in a suspension of a vehicle or a trailer such as a semi-trailer to be towed by a towing vehicle as well as increasing the accuracy of the load cells for measuring the load applied to the vehicle or trailer such as a semi-trailer.

In accordance with particular embodiments of the invention the above is accomplished by locating one or more particular type of load cells (such as load cells or load cell pins and particular type of pivot joints (such as low friction and lower friction pivot joints) at particular locations of the suspension and trailer.

According to a first aspect of the invention there is provided a bearing assembly for a pivot joint that attaches a rocker to a hanger of a suspension, the bearing assembly comprising a core and a sleeve adapted to receive the core, the sleeve comprising outer sections and an inner section sandwiched between the outer sections wherein the inner section comprises at least one bearing having an inner surface in mating arrangement with an outer surface of the core, and an outer surface in mating arrangement with an inner surface of the rocker.

Preferably, the bearing comprises a spherical bearing.

Preferably, the bearing is attached to each inner side of the outer sections through a flexible joint.

Preferably, each outer section is configured as truncated conical sections with their end that has the smaller diameter being attached to the bearing through a flexible joint.

Preferably, there are a plurality of bearings sandwiched between the outer sections of the outer sleeve.

Preferably, the plurality of bearings are arranged in a spaced apart relationship with respect to each other.

Preferably, neighboring bearings are joined to each other through a flexible joint.

Preferably, the core comprises an outer sleeve and an inner rod being adapted to be inserted in the outer sleeve.

Preferably, the core comprises means for securing the inner rod within the outer sleeve.

Preferably, the outer sleeve and the inner rod comprise each one a disc perpendicularly attached thereto for sandwiching the sleeve of the bearing assembly between the discs when then sleeve of the bearing assembly is surrounding the core.

According to a second aspect of the invention there is provided a pivot joint for pivotally attaching a rocker to a hanger of a suspension, the pivot joint comprising the bearing assembly in accordance with the first aspect of the invention.

According to a third aspect of the invention there is provided a suspension for a semi-trailer, the suspension comprising at least two hangers and at least two rockers for attachment of ends of spring assemblies of the suspension, and at least two pivot joints in accordance with the second aspect of the invention, wherein each rocker is pivotally attached to a hanger through one of the pivot joints.

Preferably, the suspension comprises an overslung suspension.

Alternatively, the suspension comprises an underslung suspension.

According to a fourth aspect of the invention there is provided a semi-trailer having a chassis and a tray for receiving a load, the semi-trailer comprising a pair of suspensions in accordance with the third aspect of the invention attached to each side of the chassis through the hangers, wherein the semi-trailer further comprises a weighing system having a single load cell sandwiched between a lower surface of each side of the chassis and one of the hangers, wherein at least one hanger comprises one of the pivot joints for attachment of one of the rockers.

Preferably, the load cell is located frontward with respect to the point of load of the semi-trailer.

Preferably, the chassis comprises a strong chassis

Preferably, the lower surface of each side of the chassis comprises an indentation for receiving the load cell.

In an alternative arrangement, the chassis comprises a flexible chassis. In this alternative arrangement the load cell is located rearward from the point of load of the semi-trailer.

In an alternative arrangement, the weighing system comprises a pair of load cells attached to each side of the chassis.

Preferably, the lower surface of each side of the chassis comprises two indentations, each indentation being adapted for receiving one of the load cells.

According to a fifth aspect of the invention there is provided a pin for a pivot joint that attaches a rocker to a hanger of a suspension attached to a semi-trailer, the pin comprising a body having a first section, a second section and centre section located between the first and section sections, and at least one sensor means operatively attached to the body of the pin for detecting application of load to the chassis of the semi-trailer as well as measuring the load applied to the semi-trailer.

Preferably, the sensor means comprises at least one load cell operatively engaged to the body of the pin.

Preferably, the pin comprises at least one cavity defining a shear plate for receiving the load cell.

Preferably, the pin is adapted to transfer signals between the load cell and the exterior of the pin.

Preferably, the body of the pin comprises at least one first passage extending from the cavity to the exterior of the pin for operatively connecting the load cell contained in the cavity to the exterior of the pin.

Preferably, the passage comprises a wiring hole to allow passage of conductor means through the passage.

Preferably, the body of the pin is adapted to receive a resistor board operatively connected to the load cell.

Preferably, the first end of the body of the pin comprises an aperture for receiving the resistor board.

Alternatively, the second end comprises an aperture for receiving the resistor board.

Preferably, the body of the pin comprises pair of cavities arranged in a spaced apart relationship with respect to each other along the body of the pin.

Preferably, each cavity comprises indentations extending into the body of the pin.

Preferably, there are a pair of cavities on each side of the centre section of the pin.

Preferably, each cavity has an opposite cavity located opposite to that particular cavity.

Preferably, the cavities are operatively connected to each other via second passages.

Preferably, the second passages are operatively connected to the first passage.

Preferably, each cavity comprises at least one load cell operatively engaged to the body of the pin.

Preferably, one of the ends of the body of the pin comprises a squared section to allow orientation of the pin.

Preferably, body of the pin comprises at least one section of reduced radius defining at least one indentation extending into the periphery of the pin.

Preferably, the centre section of the body of the pin comprises the indentation.

Preferably, there are at least one two indentations arranged in a spaced apart relationship with respect to each other.

Preferably, the indentations are arranged in such a manner that the indentations are located substantially at each end of the centre section of the pin.

In a particular arrangement, a plurality of grooves are arranged in a spaced apart relationship with respect to each other, each groove surrounds the periphery of the load cell at a location where each cavity extends into the load cell pin.

Preferably, the load cell pin comprises a slot extending longitudinally along the longitudinal axis of the load cell pin and between the grooves.

In a particular arrangement, the load cell comprises tapered sections adjacent each end of the load cell.

According to a sixth aspect of the invention there is provided a bearing assembly for a pivot joint that attaches a rocker to a hanger of a suspension, the bearing assembly comprising the pin in accordance with the fifth aspect of the invention and a sleeve adapted to receive the pin, the sleeve comprising outer sections and an inner section sandwiched between the outer sections wherein the inner section comprises at least one bearing having an inner surface in mating arrangement with an outer surface of the pin, and an outer surface in mating arrangement with an inner surface of the rocker.

According to a seventh aspect of the invention there is provided a pivot joint for pivotally attaching a rocker to a hanger of a suspension, the pivot joint comprising the bearing assembly in accordance with the sixth aspect of the invention.

According to an eighth aspect of the invention there is provided a suspension for a semi-trailer, the suspension comprising at least one hanger and at least one rocker for attachment of ends of spring assemblies of the suspension, and at least two pivot joints in accordance with the seventh aspect of the invention, wherein each rocker is pivotally attached to a hanger through one of the pivot joints.

Preferably, the rocker comprises means for providing lubrication to the pivot joint between the rocker and the hangers.

Preferably, the suspension comprises an overslung suspension.

Alternatively, the suspension comprises an underslung suspension

Preferably, the rocker comprises means for supporting the load cell pin within the rocker.

Preferably, the means for supporting comprises a tapered ring on each side of the rocker.

In an alternative arrangement, the means for supporting comprises a support cap on each side of the rocker.

According to a ninth aspect of the invention there is provided a pivot joint for pivotally attaching a rocker to a hanger of a suspension, the pivot joint comprising a load cell pin in accordance with the fifth embodiment of the invention and a bearing assembly comprising a plurality of bushes adapted to surround the load cell pin.

Preferably, each bush comprises a body having an inner end and an outer end; the surface areas of the outer end being greater than the surface area of the inner end.

Preferably, the bearing assembly is defined by arranging the bushes in a spaced apart relationship with respect to each other with the inner ends of each bush facing each other.

Preferably, each of the bushes comprises one or more grooves arranged in a spaced apart relationship with respect to each other around the outer surface of the body of the bush.

Preferably, the grooves extend partially from an inner end of the body of the bush towards an outer end of the body of the bush.

Preferably, each groove comprises an open end located at the inner end of the bush.

Preferably, each bush comprises a metal bearing extending into the bush from the inner end.

Preferably, the metal bearing is configured in such a manner that an end of the metal bearing aligns with the shear plate of the load cell pin.

According to a tenth aspect of the invention there is provided a suspension for a semi-trailer, the suspension comprising at least one hanger and at least one rocker for attachment of ends of spring assemblies of the suspension, and at least one pivot joint in accordance with the ninth aspect of the invention, wherein the rocker is pivotally attached to a hanger through one of the pivot joints.

According to an eleventh aspect of the invention there is provided a semi-trailer having a chassis and a tray for receiving a load, the semi-trailer comprising a pair of suspensions, each suspension comprising at least two hangers and at least two rockers for attachment of ends of spring assemblies of the suspension, and at least two pivot joints, wherein each rocker is pivotally attached to a hanger through one of the pivot joints, each suspension being attached to each side of the chassis through a plurality of hangers, wherein the semi-trailer further comprises a weighing system having a load cell sandwiched between a lower surface of each side of the chassis and a first hanger of the plurality of hangers, wherein at least one second hanger of the plurality of hangers comprises a pivot joint in accordance with either the ninth aspect of the invention or the second aspect of the invention for pivotally attaching one of the rockers to the second hanger.

Preferably, the first pivot joint comprises a pivot joint in accordance with either the ninth aspect of the invention or the second aspect of the invention for pivotally attaching one of the rockers to the first hanger.

Preferably, each load cell is located frontward with respect to the point of load of the semi-trailer.

Preferably, the chassis comprises a strong chassis.

Preferably, the lower surface of each side of the chassis comprises an indentation for receiving the load cell.

In an alternative arrangement, the chassis comprises a flexible chassis. In this alternative arrangement the load cell is located rearward from the point of load of the semi-trailer.

In an alternative arrangement, the weighing system comprises a pair of load cells attached to each side of the chassis.

Preferably, the lower surface of each side of the chassis comprises two indentations, each indentation being adapted for receiving one of the load cells.

According to a twelfth aspect of the invention there is provided a semi-trailer having a chassis and a tray for receiving a load, the semi-trailer comprising a pair of suspensions in accordance with the tenth aspect of the invention attached to each side of the chassis through a plurality of hangers, wherein at least one another hanger comprises a pivot joint in accordance with the ninth aspect of the invention and/or the second aspect of the invention for pivotally attaching one of the rockers to the first hanger.

According to a thirteenth aspect of the invention there is provided a bush for defining a bearing assembly for a pivot joint joining together a rocker and a hanger of a suspension for a semi-trailer; wherein the bush comprises one or more grooves arranged in a spaced apart relationship with respect to each other around the outer surface of the body of the bush.

Preferably, the grooves extend partially from an inner end of the body of the bush towards an outer end of the body of the bush.

Preferably, each groove comprises an open end located at the inner end of the bush.

Preferably, each bush comprises a metal bearing extending into the bush from the inner end.

Preferably, the metal bearing is configured in such a manner that an end of the metal bearing aligns with the shear plate of the load cell pin.

According to a fourteenth aspect of the invention there is provided a bearing assembly comprising a plurality of bushes in accordance with the thirteenth aspect of the invention, the bushes being arranged in a spaced apart relationship with respect to each other with inner ends of each bush facing each other.

Preferably, each bush comprises a body having an inner and an outer end; the surface areas of the outer end being greater than the surface area of the inner end.

Preferably, the body of the bush comprises a conical bush.

According to a fifteenth aspect of the invention there is provided a bearing assembly comprising an inner bush and an outer bush, the inner and outer bushes being arranged in a spaced apart relationship with respect to each other with inner ends of each bush facing each other, wherein the bodies of the inner bush and outer bush differ in length with respect to each other.

Preferably, the inner bush is of greater length than the outer bush.

Preferably, each of the inner bush and the outer bush comprises a bush in accordance with the thirteenth aspect of the invention.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is a schematic side view of a rear section of a semi-trailer in accordance with the prior art.

FIG. 2 is a schematic side view of a suspension in accordance with a first embodiment of the invention;

FIG. 3 is a schematic view of a first arrangement of a rocker and hanger assembly of the suspension shown in FIG. 2;

FIG. 4 is a schematic perspective view of a bearing assembly in accordance with the first embodiment of the invention in disassembled condition;

FIG. 5 is a schematic side view of a rear section of a first arrangement of a semi-trailer in accordance with the first embodiment of the present invention;

FIG. 6 is a schematic side view of a rear section of a second arrangement of a semi-trailer in accordance with the first embodiment of the present invention;

FIG. 7 is a schematic side view of a suspension in accordance with a second embodiment of the invention;

FIG. 8 is a schematic top view of the suspension shown in FIG. 7;

FIG. 9 is a schematic view of a rocker of the suspension shown in FIG. 7;

FIG. 10 is a schematic top perspective view of a bearing assembly in accordance with the second embodiment of the invention;

FIG. 11 is a schematic side view of the bearing assembly shown in FIG. 10;

FIG. 12 is a schematic perspective side view of a first arrangement of a load cell pin in accordance with the second embodiment of the invention;

FIG. 13 is a schematic side view of the load cell pin shown in FIG. 12;

FIG. 14 is a schematic cross sectional view of the pin shown in FIG. 12;

FIG. 15 is a schematic end view of the bearing assembly shown in FIG. 10;

FIG. 16 is a schematic cross sectional view along the line A-A′ of the bearing assembly shown in FIG. 15;

FIG. 17 is a schematic cross sectional view along the line B-B′ of the bearing assembly shown in FIG. 15;

FIG. 18 is a schematic perspective side view of a second arrangement of a load cell pin in accordance with the second embodiment of the invention;

FIG. 19 is a schematic side view of the load cell pin shown in FIG. 18;

FIG. 20 is a schematic cross sectional view along the line 20-20′ of the pin shown in FIG. 19;

FIG. 21 is a schematic cross sectional view along the line 21-21′ of the pin shown in FIG. 19;

FIG. 22 is a schematic front view of a washer to be used in conjunction with the load cell pin shown in FIG. 18;

FIG. 23 is a schematic view of a second arrangement of a rocker of the suspension shown in FIG. 2;

FIG. 24 is a schematic cross sectional view along the line 24-24′ of the rocker shown in FIG. 23;

FIG. 25 is a schematic front view of a support cap to be used in conjunction with the rocker shown in FIG. 23;

FIG. 26 is a schematic side view of the cover shown in FIG. 25;

FIG. 27 is a schematic view of a third arrangement of a rocker of the suspension shown in FIG. 2.

FIG. 28 is a schematic cross sectional view along the line 28-28′ of the rocker shown in FIG. 27;

FIG. 29 is a schematic top view of the suspension in accordance with a third embodiment of the invention;

FIG. 30 is a schematic side view of a suspension in accordance with a fourth embodiment of the invention;

FIG. 31 is a schematic top view of the suspension shown in FIG. 30;

FIG. 32 is a schematic side view of the rear of a trailer including a suspension in accordance with a fifth embodiment of the invention;

FIG. 33 is a schematic side view of a suspension in accordance with a first arrangement of a sixth embodiment of the invention;

FIG. 34 is a schematic side view of a suspension in accordance with a second arrangement of the sixth embodiment of the invention;

FIG. 35 is a rear perspective view of a bush assembly in accordance with a seventh embodiment of the invention;

FIG. 36 is a top perspective view of a bush shown in FIG. 35;

FIG. 37 is a schematic side view of a bearing in accordance with the prior art;

FIG. 38 is a schematic side view of a bearing in accordance with an eight embodiment of the invention;

FIG. 39 is a schematic view of a second arrangement of a rocker and hanger assembly of the suspension shown in FIG. 2;

FIG. 40 is a schematic cross sectional view along the line 40-40′ of the rocker shown in FIG. 39;

FIG. 41 is a schematic cross sectional view along the line 40-40′ of the rocker shown in FIG. 39 incorporating a bearing assembly defined by the bushes shown in FIGS. 35 and 36;

FIG. 42 is a schematic side view of a third arrangement of a load cell pin in accordance with the second embodiment of the invention;

FIG. 43 is a schematic side view of particular arrangements of washer adapted to abut the ends of the bushes.

FIG. 44 is a schematic side view of a trailer including a suspension in accordance with the prior art; and

FIG. 45 is a schematic side view of a trailer including a suspension in accordance with the prior art.

It should be noted that the figures are schematic only and the location and disposition of the components can vary according to the particular arrangements of the embodiments of the present invention as well as of the particular applications of these embodiments.

### DESCRIPTION OF EMBODIMENT(S)

The suspension system in accordance with a first embodiment of the invention permits reducing the number of load cells 14 incorporated in a suspension 20 of a vehicle or a trailer such as a semi-trailer to be towed by a towing vehicle as well as increasing the accuracy of the load cells for measuring the load applied to the vehicle or trailer such as a semi-trailer.

In accordance with particular embodiments of the invention the above is accomplished by locating one or more particular type of load cells (such as load cells 14 or load cell pins 62) and particular type of pivot joints 34 (such as low friction and lower friction pivot joints 34) at particular locations of the suspension and trailer.

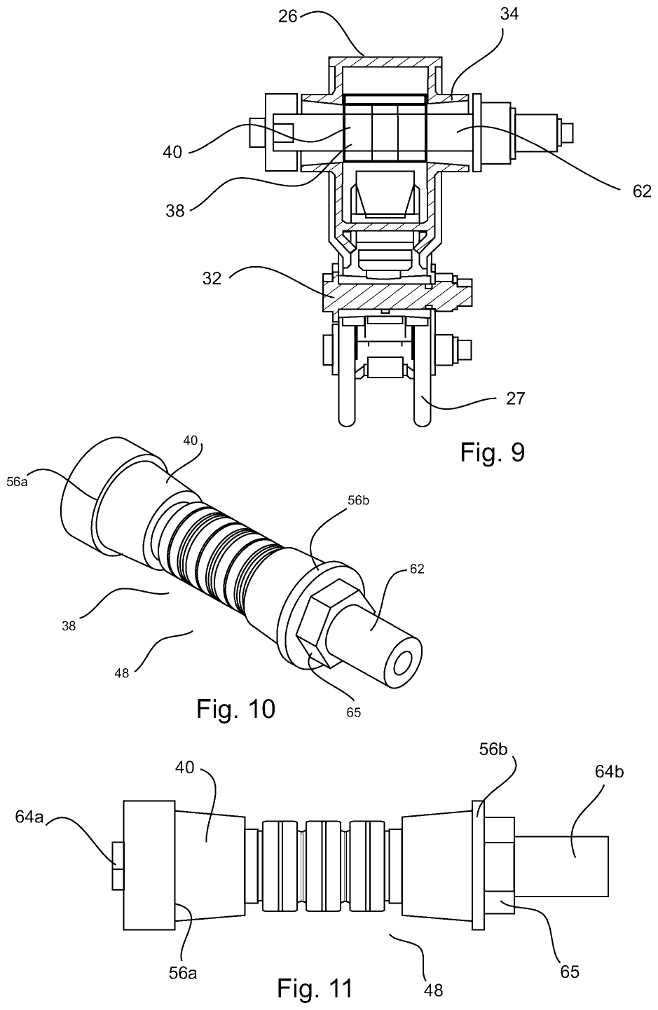

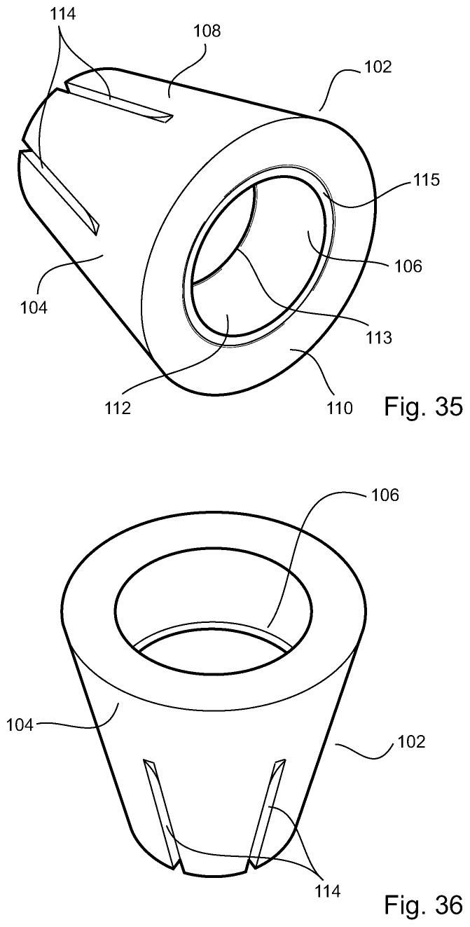

In accordance with a particular embodiment of the invention reduction of the number of load cells 14 is accomplished through the use of pivot joints 34 (that pivotally attach the suspension rockers 32 to the hangers 26) of reduced friction. For example, as will be described below, a particular pivot joint 34 may include a pivot joint 34 of low friction comprising a bearing assembly 118 comprising greaseable bushes 102—see FIGS. 35, 36 and 38. In other arrangements, the pivot joint 34 may be a lower friction pivot joint 34 comprising bearing assemblies 48 as for example shown in FIGS. 4 and 10. In the present specification, pivot joints 34 incorporating bearing assemblies 118 will be referred to as low friction pivot joints 34; and, pivot joints 34 incorporating bearing assemblies 48 will be referred to as lower friction pivot joints 34.

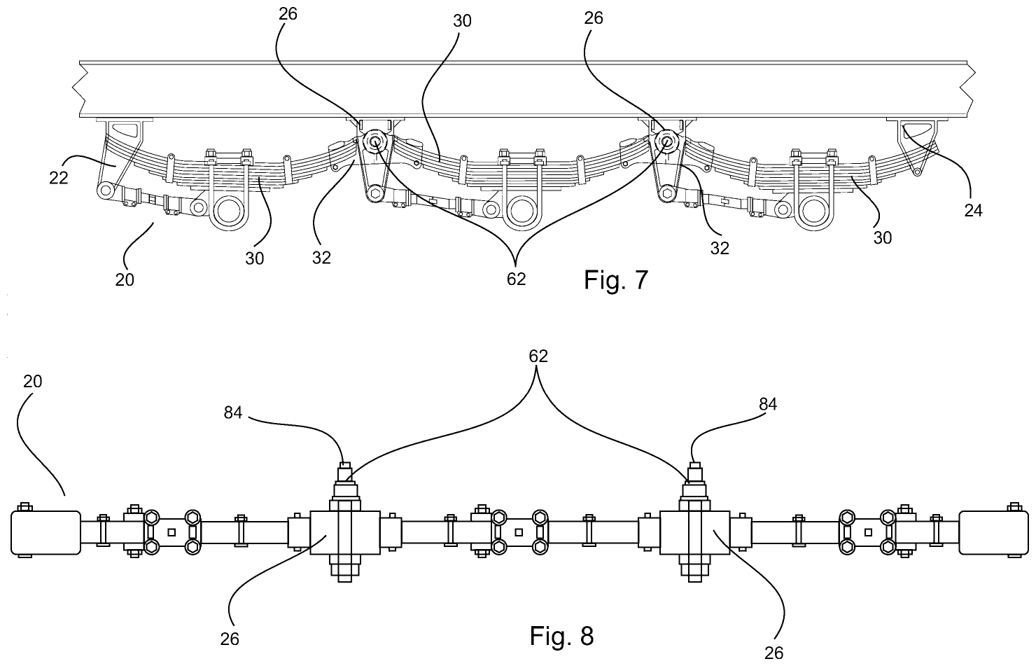

In a second embodiment of the invention, there is provided a suspension 20 incorporating load cell pins 62 for defining the pivot joint 34 that pivotally attaches rockers 32 to hangers 26 of the suspension 20—see FIGS. 7 and 8.

Further, in accordance with other embodiments of the invention, the suspension 20 may incorporate at least one low friction pivot joint 34 and at least one lower friction pivot joint 34. In particular embodiments of the invention, the number and location of the low and lower friction pivot joints 34 may be chosen such as to increase the accuracy of measurement of the load cells.

Referring now to FIGS. 2 to 11.

FIG. 2 shows a suspension 20 in accordance with a particular arrangement of the first embodiment of the invention. The suspension 20 in accordance with present arrangement comprises an overslung suspension wherein the leaf spring assemblies 30 are located over the wheel axle. In accordance with alternative arrangements of the first embodiment the suspension 20 may comprise an underslung suspension wherein the leaf spring assemblies 30 are located under the wheel axle.

The suspension 20 depicted in FIG. 2 comprises a front hanger 22 and a rear hanger 24 as well as a pair of middle hangers 26. The hangers 22, 24 and 26 are arranged in spaced apart relationship with respect to each other and joined together by leaf spring assemblies 30. The middle hangers 26 are attached to respective ends of the spring assemblies 30 via rockers 32.

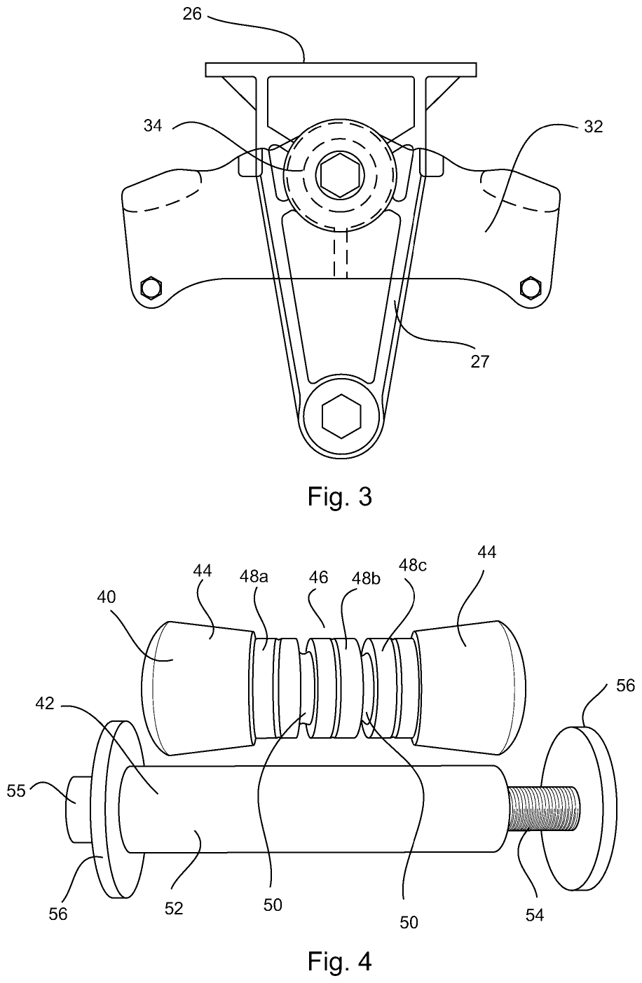

FIG. 3 depicts one of the middle hangers 26 incorporating a rocker 32. For attaching the rocker 32 to the hanger 26, the hanger 26 comprises two portions 27 spaced apart with respect to each other defining a gap adapted to receive the rocker 32.

Further, each of the two portions 27 of the hanger 26 at their upper end comprises an aperture 36. And, the rocker 32 comprises an aperture traversing the upper portion of the rocker 32. For attachment of the rocker 32 to the hanger 26, the rocker 32 is inserted between the two portions 27 until the apertures 36 of the hangers 26 and the apertures of the rocker 32 coincide to define a passage traversing the hanger 26 and the rocker 32 when the rocker is inserted between the two portions 27 of the hanger 26. This allows pivotally attaching the rocker 32 to the hanger 26 via pivot joints 34. In a particular arrangement, the pivot joint 34 may comprise a low friction pivot joint 34 as was defined before; in another arrangement, the pivot joint 34 may comprise a lower friction pivot joint 34 as was defined before.

The rockers 32 are pivotally attached to the middle hangers 26 through a pivot joint 34. In this manner the rocker 32 may pivot with respect to the hanger 26.

The pivot joined 34 is defined by (1) the passage defined by the aperture traversing the rocker 32 and the apertures 36 traversing the hanger 26 and (2) a bearing assembly 38 traversing this passage.

We refer now to FIG. 4. FIG. 4 depicts a bearing assembly 38 in accordance with a particular arrangement of the present invention.

As shown in FIG. 4, the bearing assembly 38 comprises a sleeve 40 and a core 42 adapted to be received by the sleeve 40 so that a centre section of the core 42 is surrounded by the sleeve 40 defining the bearing assembly 38.

The sleeve 40 comprises two outer sections 44 and a centre section 46. Each outer section 44 is adapted be received by the apertures 36 of the hanger 26. The centre section 46 is adapted to be received by the aperture traversing the rocker 32.

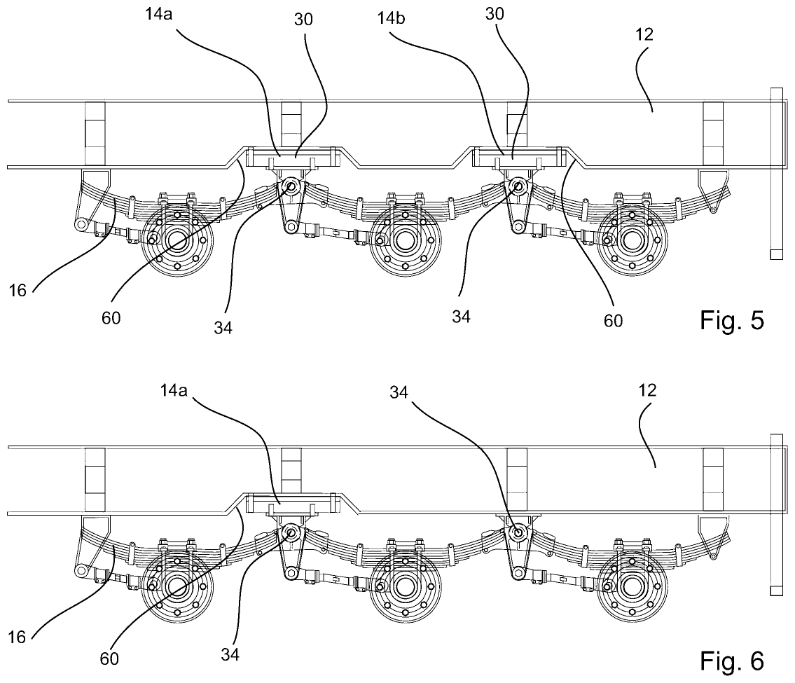

The centre section 46 comprises a plurality of bearings 48. The bearings 48 are arranged in a spaced apart arrangement with respect to each other and joined together to define the centre section 46. In the particular arrangement shown in FIG. 5, the bearings 48 are joined to each other through flexible joints 50 permitting movement of a particular bearing, for example, 48a with its neighboring bearing 48b.

In the present embodiments, the bearings 48 comprise spherical bearings; in accordance with other arrangements the bearing may include any type of bearings such as needle bearings or bushes among others or combinations thereof.

The outer sections 44 of the sleeve 40 are configured as conical bodies with the end having the smaller diameter attached to the respective bearing 48a or 48c. In the particular arrangement shown in FIG. 5, the bearings 48a and 48c are joined to the outer sections 44 though flexible joints 50 permitting movement of the outer sections 44 with their respective neighboring bearing (48a or 48c).

Referring now to the core 42 of the bearing assembly 38, the core 42 comprises an outer sleeve 52 and an inner rod 54. The inner rod 54 is adapted to be inserted in the outer sleeve 52 and comprises means for securing the inner rod 54 within the outer sleeve 52. In the particular arrangement shown in the FIG. 4, the inner rod 54 comprises a threaded outer surface allowing (1) sliding of the inner rod 54 into the outer sleeve 52 and (2) fasten the inner rod 54 to a nut 55 located at an end of the outer sleeve 52.

Further, the outer sleeve 52 and the inner rod 54 comprise each one a disc 56 (also referred to as washers 56) perpendicularly attached thereto. This allows sandwiching the sleeve 40 between the discs 56 when the sleeve 40 is surrounding the inner section of the core 42. The discs 56 also cover the outer opening of the apertures 36 of the hanger 26.

We refer now to FIGS. 5 and 6. FIGS. 5 and 6 show the rear sections of semi-trailers incorporating first and second arrangements of suspension systems 12 in accordance with the first embodiment of the invention.

FIG. 5 shows the semi-trailer incorporating the first arrangement of the suspension 16. The particular arrangement of the semi-trailer shown in FIG. 5 comprises at each side of the semi-trailer a pair of load cells 14a and 14b. (This is in contrast with the semi-trailers of the prior art that include at each side four load cells 14a to 14d).

FIG. 6 shows the semi-trailer 12 incorporating the second arrangement of the suspension 16. The particular arrangement of the semi-trailer shown in FIG. 6, comprises at each side of the semi-trailer a pair of load cells 14a and 14b. This is also in also contrast with the semi-trailers of the prior art that include, at each side, four load cells 14a to 14d.

In this second arrangement, the chassis is a strong chassis. Due to being a strong chassis the load cell is located frontward with respect to the point of load of the semi-trailer as depicted in FIG. 6.

In an alternative configuration of this second arrangement the chassis is a flexible chassis. In this alternative configuration, the load cell would be located rearward from the point of load of the semi-trailer at the location of load cell 14b as depicted in FIG. 5.

The first and second arrangements of the semi-trailer shown in FIGS. 5 and 6 incorporate pivot joints 34 in accordance with the first embodiment of the invention. These pivot joints 34 have been described in the previous paragraphs. As mentioned earlier the pivot joints 34 allow pivotal moment of the rockers 32 with respect to the hangers 30. In the particular arrangements depicted in FIGS. 5 and 6 there are for each rocker 32 a pivot joint 34 in accordance with the first embodiment of the invention.

The fact that the suspensions 20 in accordance with the first embodiment of the invention comprise the above described pivot joints 34 permits the suspension 20 to equalise more freely due to the relative low friction that the bearing assembly 38 in accordance with the first embodiment of the invention provides. This is particularly advantageous because due to the incorporation of the pivot joints 34 in accordance with the first embodiment of the invention it is possible to reduce the number of load cells 14 needed for measuring the load that is applied to the semi-trailer during the loading and transporting process of materials.

Moreover, the particular arrangement of semi-trailer in accordance with the present invention shown in FIGS. 5 and 6 comprises a tray which lower surface is adapted to receive the load cell 14 or load cells 14. As shown in FIGS. 5 and 6, the lower surface 58 of the tray 12 comprises indentations 60 adapted to receive the load cells 14.

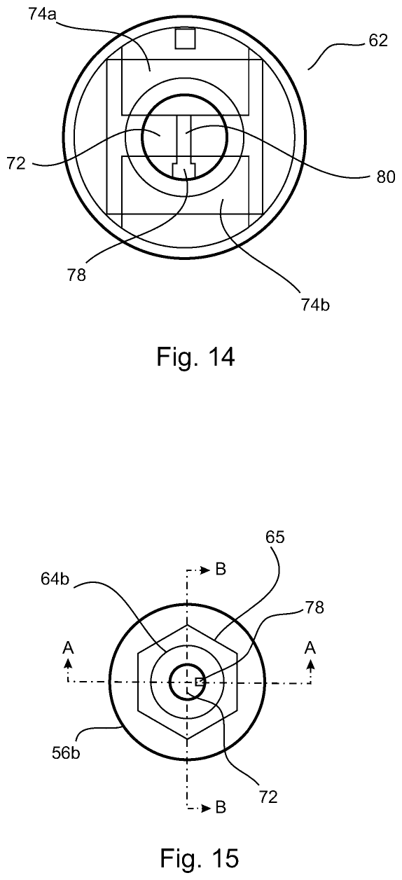

Referring now to FIGS. 7 to 17.

FIGS. 7 to 17 show a suspension and a bearing assembly according to a second embodiment of the invention. The suspension 20 and the bearing assembly 38 according to the second embodiment is similar to the suspension and the bearing assembly 38 according to the first embodiment and similar reference numerals are used to identify similar parts.

FIGS. 7 and 8 show a particular arrangement of a suspension 20 in accordance with a second embodiment of the invention.

The suspension 20 in accordance with the present arrangement comprises an overslung suspension wherein the leaf spring assemblies 30 are located over the wheel axle. In accordance with alternative arrangements of the second embodiment of the invention, the suspension 20 may comprise an underslung suspension wherein the leaf spring assemblies 30 are located under the wheel axle.

The suspension 20 depicted in FIGS. 7 and 8 comprises a front hanger 22 and a rear hanger 24 as well as a pair of middle hangers 26. The hangers 22, 24 and 26 are arranged in spaced apart relationship with respect to each other and joined together by leaf spring assemblies 30. The middle hangers 26 are attached to respective ends of the spring assemblies 30 via rockers 32.

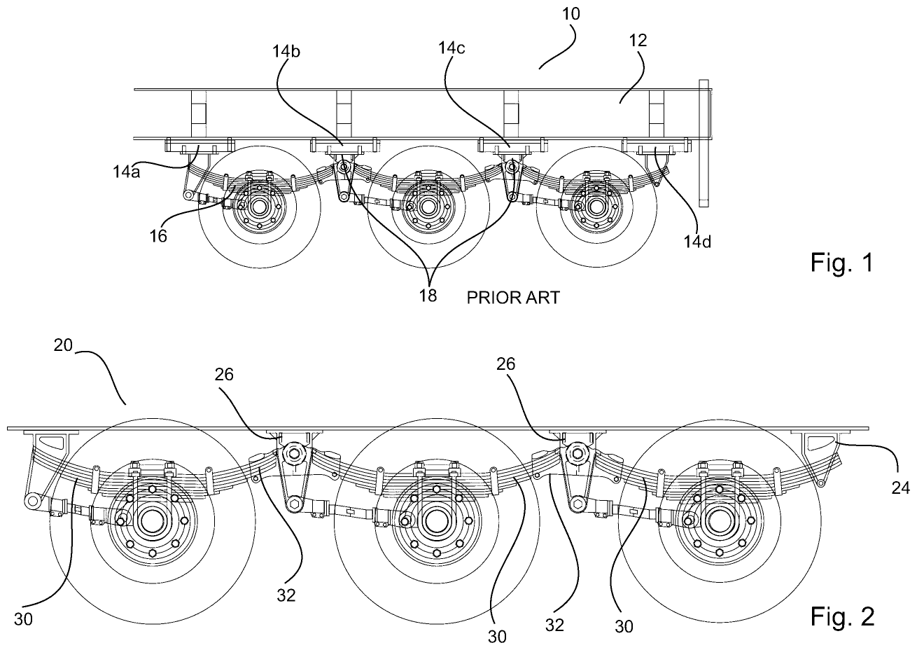

As was described with reference to FIGS. 1 to 6, the suspension 20 in accordance with the first embodiment of the invention comprises a reduced number of load cells 14. For example, the particular arrangement of suspension shown in FIG. 6, comprises at each side of the semi-trailer a pair of load cells 14a and 14b for measuring the load applied to the chassis of the semi-trailer due to the cargo mounted on the semi-trailer incorporating the suspension 20.

In contrast, in accordance with particular arrangements of the second embodiment of the invention no load cells 14 are attached to the chassis of the semi-trailer. Instead, the suspension 20 in accordance with the second embodiment of the invention comprises load cell pins 62. The load cell pins 62 are incorporated in the pivot joints 34 that permit pivotal movement of the rockers 32 with respect to the hangers 30.

The fact that the suspensions 20 in accordance with the second embodiment of the invention comprise the load cell pins 62 incorporated in the pivot joints 34 permits in a particular arrangement replacing one or more load cells 14 or even omitting the load cells 14 all together One or more load cells 14 may be replaced or omitted because the pins 62 of the pivot joints 34 incorporate load cells that are adapted to measure the load applied to the suspension 20.

Referring now to FIGS. 9 to 14.

FIG. 9 shows a cross sectional view of the suspension 20 along a line traversing a hanger 26. The pivot joint 34 shown in FIG. 9 comprises a load cell pin 62 in accordance with the second embodiment of the invention.

A sleeve 40 surrounds the load cell pin 62. The sleeve 40 comprises a plurality of bearings 48. In this manner, the load cell pin 62 and the sleeve 40 define a bearing assembly 38. As was described with reference to the first embodiment of the invention, this particular arrangement of bearing assembly 38 permits the suspension 20 equalise more freely due to the relative low friction that the bearing assembly 38 in accordance with the present embodiments of the invention provides.

As mentioned before, the pivot joint 34 comprises a load cell pin 62 in accordance with the second embodiment of the invention that permits measuring the load applied to the chassis.

FIGS. 10 and 11 show the bearing assembly 38 including the load cell pin 62 according to a first arrangement of the second embodiment of the invention and the sleeve 40.

The load cell pin 62 comprises a center section 63, and first and second ends 64a and 64b. The pin 62 traverses the sleeve 40. The sleeve 40 is sandwiched between washers 56a and 56b. The washers 56 are releasably attached to the ends 64a and 64b of the pin 62; in particular washer 56a is abutted against a stepped section of one of the ends of the pin 62 and washer 56b is abutted against an end of the sleeve 40. The sleeve 40 is maintained over the pin 62 by a nut 65 screwed onto the end 64b of the pin 62.

The bearing assembly 38 is assembled by sliding the washer 56a over the pin 62 until it abuts the stepped section 68 at the end 64a. Subsequently, the sleeve 40 is slid over the pin 62, and the washer 56b is slid over the pin 62 until it abuts the sleeve 40. The nut 65 is screwed onto the end 64b of the pin 62 until the sleeve 40 is sandwiched between the washers 56 to secure the sleeve 40 onto the pin.

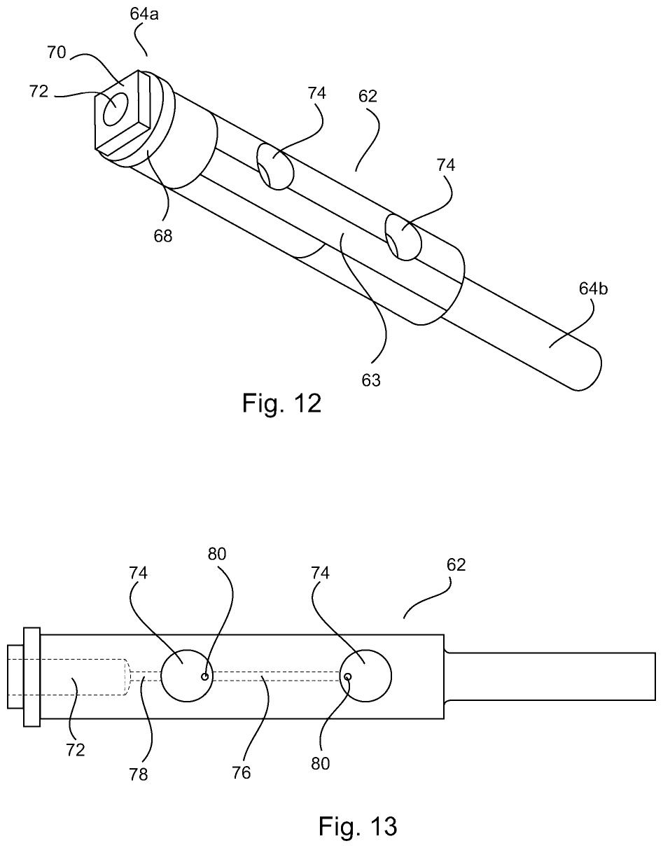

FIGS. 12 to 14 show a first arrangement of the load cell pin 62 according to the second embodiment of the invention.

As shown in FIG. 12, the end 64a of the pin 62 comprises the stepped section 68 for abutment of the washer 56a to retain the sleeve 40 over the pin 62.

Further, the end 64a of the pin 62 comprises a squared section 70 attached to the stepped section 68. The square section 70 allows attachment of a spanner for orienting the pin 62 when the bearing assembly 38 (defined by the pin 62 and the sleeve 40) is inserted in the rocker 30.

Furthermore, the pin 62 comprises an aperture 72 traversing the square section 70 into the end 64a. The aperture 72 allows communication between the exterior of the pin 62 and the interior of the pin 62. This permits obtaining signals to be generated within the pin 62 to be delivered to exterior of the pin 62. In particular, wiring may extend from the interior of the pin 62 to the aperture 72. In a particular arrangement, the square section 70 is adapted to receive a resister board for operative connection to the loads cells of the pin 62.

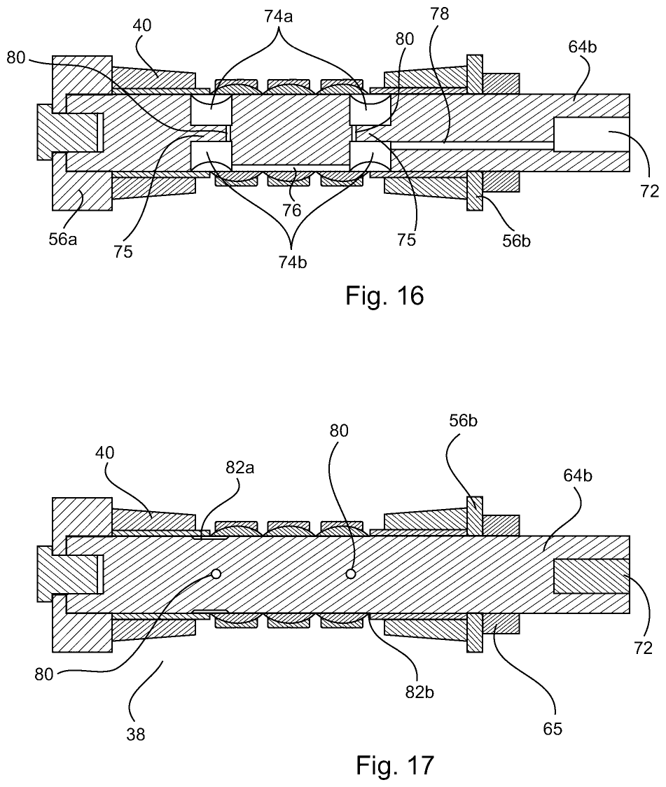

Referring now to FIG. 13, FIG. 13 is schematic view of the interior of the pin 62. The pin 62 comprises cavities 74a and 74b; in the particular arrangement shown in the figures, a pair of cavities are arranged in a spaced apart relationship with respect to each other along the pin 62. Each cavity 74 comprises indentations extending into the centre section 63 of the pin 62.—see, for example FIG. 16. There are a pair of cavities 74 on each side of the centre section 63 of the pin 62. Each cavity 74a has a cavity 74b (the opposite cavity 74b) located opposite to that particular cavity 74a.

As shown in FIG. 16, the fact that cavities 74a and 74b are arranged opposite to each other define a shear plate 75 between each pair of opposite cavities 74a and 74b. In particular arrangements, the shear plates 75 may comprise relative thick shear plate 75.

The cavities 74 are connected to each other through passages 76 and 80. Passage 78 extends from the cavities 74 to the aperture 72 allowing communication between exterior of the pin 62 and the cavities 74. Further, passages 80 allow communication between opposite cavities 74a and 74b.

In the particular arrangement shown in the FIGS. 12 to 14, the cavities 74 are operatively connected to one of the ends 64 of the pin 62. In particular, the cavities 74 are operatively connected to the end 64a that comprises the stepped section 68 for abutment of the washer 56a. However, in an alternative arrangement, the cavities 74 may be operatively connected to the end 64b of the pin 62. This end 64b is the end that is adapted to receive the nut 65 for securing the sleeve between the washers 56. This alternative arrangement is shown in FIGS. 15 to 17.

In the particular arrangement of pin 62 shown in FIGS. 15 to 17, the end 64a comprises the aperture 72 that permits communication between the interior and the exterior of the pin 62. Communication between the exterior and interior of the pin 62 is conducted through passage 78 that extend from a cavity 74 to the aperture 72. The cavities are operatively connected to each other via passages 76 and 80—see FIG. 16.

It was mentioned before, that the pin 62 comprises load cells for measuring the load applied to the chassis of the semi-trailer comprising the suspension 20. In accordance with the second embodiment of the invention, the load cells are included in the cavities 74. There is a load cell in each cavity 74. The load cells are operatively engaged to the body of the pin 62; for example, the load cells are attached to the body of the pin such that the load cells are deformed due to deformation of the pin 62 when load is applied to the chassis of the semi-trailer. Deformation of the loads cells (also referred to as strain gauge) vary a particular characteristic of the load cell, such as the electrical resistance of the load cell. The variation of the electrical resistance is proportional to the deformation of the load cells; thus measurement of the variation of the electrical resistance provides an indication of the magnitude of the deformation. By delivering electrical signals representative of the variation of the electrical resistance to processing systems and visualization means it is p[possible to obtain a representation of the load that is being applied to the chassis of the semi-trailer.

The load cells are operatively connected to each other via passages 80. The passage 80 comprises wiring holes for permitting conductors to operatively connect the load cells together.

Further, the load cells may be operatively connected to a resistor board permitting measuring the electrical resistance of the load cells during deformation of the load cells as cargo is mounted on the semi-trailer. For this, passage 78, that communicates the cavities 74 with the exterior of the pin 62, comprises a wiring hole permitting passage of conductors from the load cells to the aperture 72. The aperture 72 may comprise a resistor board. For collecting the respective signals, the ends 64a or 64b may comprise a data plug 84 (see FIG. 8) to permit operatively connecting processing systems and visualization means to the load cells. This allows collection of the signals for processing and visualization of the amount of load that is being applied to the chassis of the semi-trailer during loading of cargo onto the semi-trailer.

Moreover, the pin 62 in accordance with either the first or second arrangement described in the previous paragraphs may include a centre section having sections of reduced radius defining indentations 82 extending into the periphery of the pin 62. In the particular arrangement shown in FIG. 17, there are two indentations 82a and 82b arranged in a spaced apart relationship with respect to each other in such a manner that the indentations 82a and 82b are located substantially at each end of the centre section 63 of the pin 62.—see FIG. 17. The indentations are provided for shear load transfer.

In particular arrangements of the second embodiment of the invention, the rockers 30 comprises means for providing lubrication to the joint between the rocker 20 and the hangers 26 to which the rockers 30 are pivotally attached.

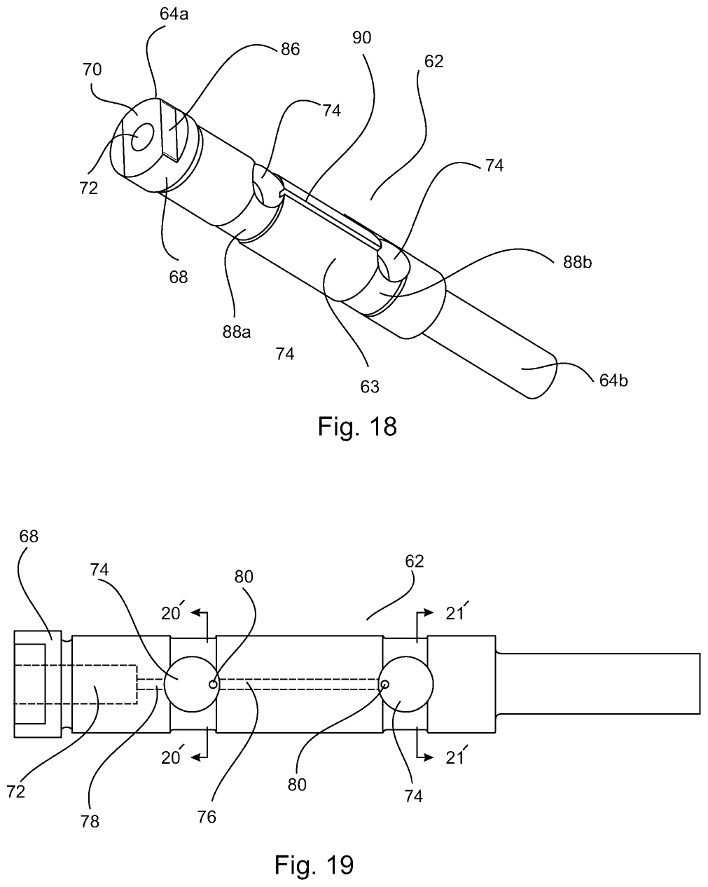

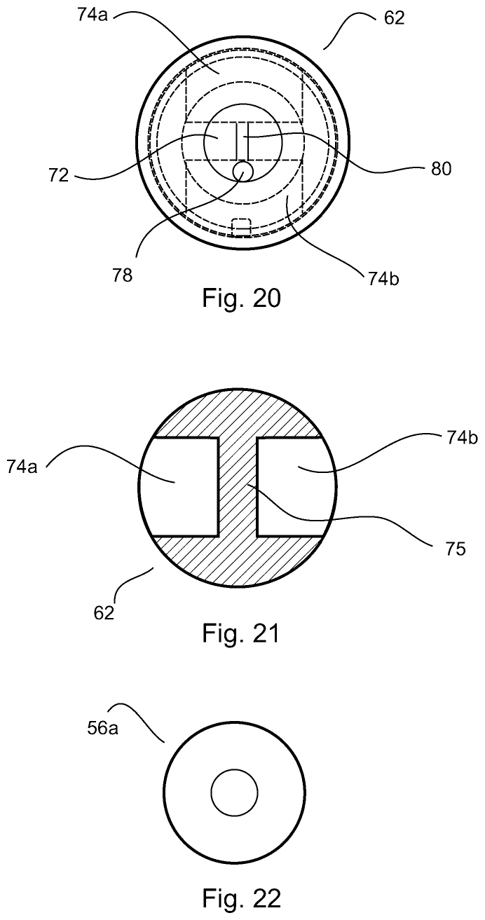

Referring now to FIGS. 18 and 19.

FIGS. 18 and 19 show a second arrangement of a load cell pin 62. The load cell pin 62 according to the second arrangement is similar to the load cell pin 62 according to the first arrangement and similar reference numerals are used to identify similar parts.

As shown in FIG. 18, the load cell pin 62 comprises an end 64a having two opposing faces 86 extending inwardly and perpendicularly from the stepped section 68.

The second arrangement of the load cell pin 62 comprises a plurality of grooves 88a and 88b arranged in a spaced apart relationship with respect to each other. Each groove 88 surrounds the periphery of the load cell pin 62 at a location where each cavity 74 extend into the load cell pin 62. The grooves 88 are defined by section of reduced radius permitting shear load transfer.

Further, the load cell pin 62 shown in FIG. 18 there comprises a slot 90 extending longitudinally along the longitudinal axis of the load cell pin 62 and between the grooves 88a and 88b.

Furthermore, the second arrangement of load cell pin 62 depicted in FIG. 18 differs from the first arrangement of the load cell pin 62 shown in FIG. 12 in that the spacing between the cavities 74 containing the load cells is greater than the spacing between the load cell pin 62 in accordance with the first arrangement and shown in FIG. 12.

Particular rockers 32 may require particular load cell pins 62 that are designed so as to place the load cells (also referred to as strain gauges) in the suitable location for providing accurate load measurements.

In fact, FIGS. 12 and 18 depict particular arrangements of the load cell pins 62 in accordance with the first and second arrangements. In accordance with alternative arrangements, the load cell pins 62 depicted in FIGS. 12 and 18 may differ from other load cell pins 62 in that the spacing between the cavities 74 may be greater or lesser with respect to other load cell pins 62. Providing load cell pins 62 with different spacing between the cavities 74 permits, for example, use of the most suitable load cell pin 62 to particular suspension systems 20.

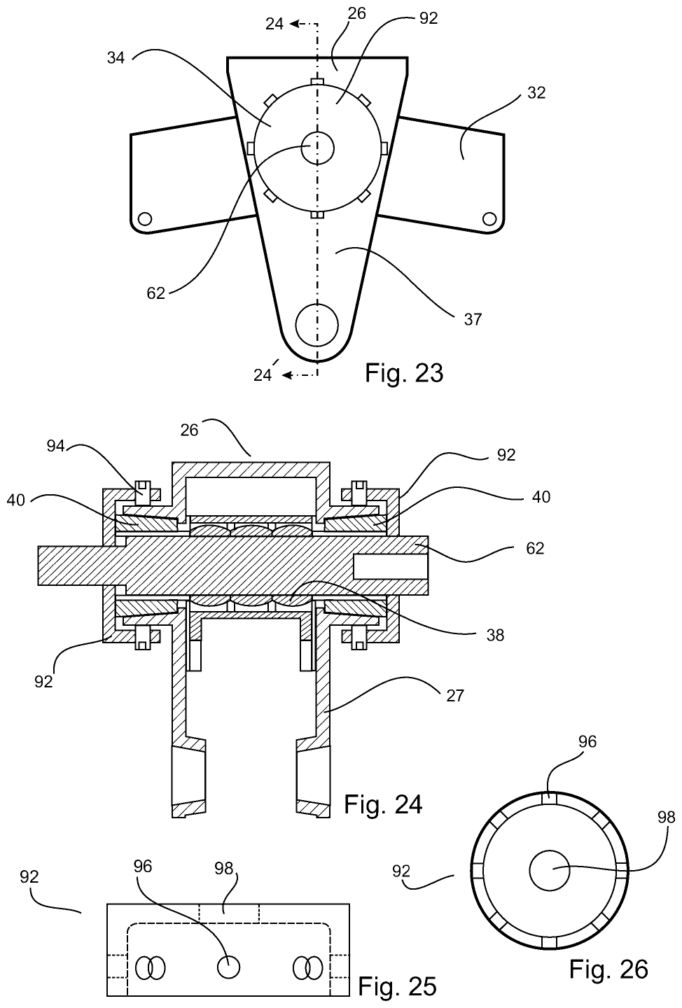

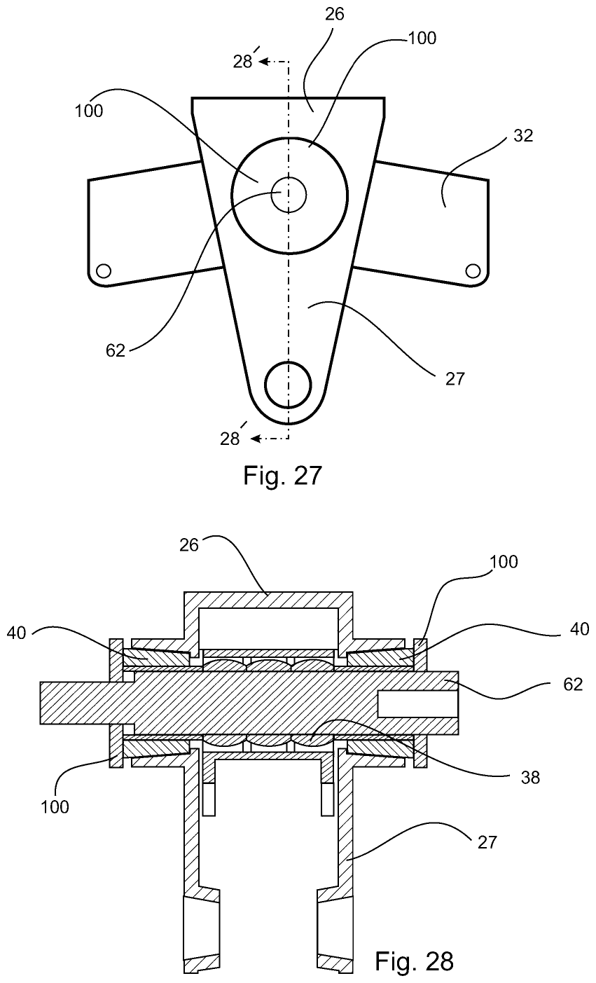

Referring now to FIGS. 23 to 28. FIGS. 23 to 28 show particular arrangements of rockers 32 for incorporating load cell pins 62 in accordance with the present embodiment of the invention. These arrangements of rockers 32 differ with respect to each other in having different types of means for supporting the load cell pin 62 in the rocker 32.

In particular, FIGS. 23 to 26 refer to a first arrangement of a rocker 32 and hanger 26 assembly. The rocker 32 shown in FIG. 23 comprises a support cap 92 mounted on each side of the rocker 32 for supporting the load cell pin 62 in the rocker 32 and the hanger 26. The support caps 92 comprise side walls having a plurality of openings 96 for receiving fastening means 94 as shown in FIG. 24. Each support cap 92 comprises an opening 98 for the ends of the load cell pins 62 to traverse thereto when the support caps 92 are mounted onto the rocker 32 as depicted in FIGS. 23 and 24.

FIGS. 23 to 26 refer to a second arrangement of a rocker 32. In this particular arrangement, the rocker 32 comprises a tapered rings 100 mounted on each side of the rocker for securing the load cell pin 62 to the rocker 32 and the hanger 26.

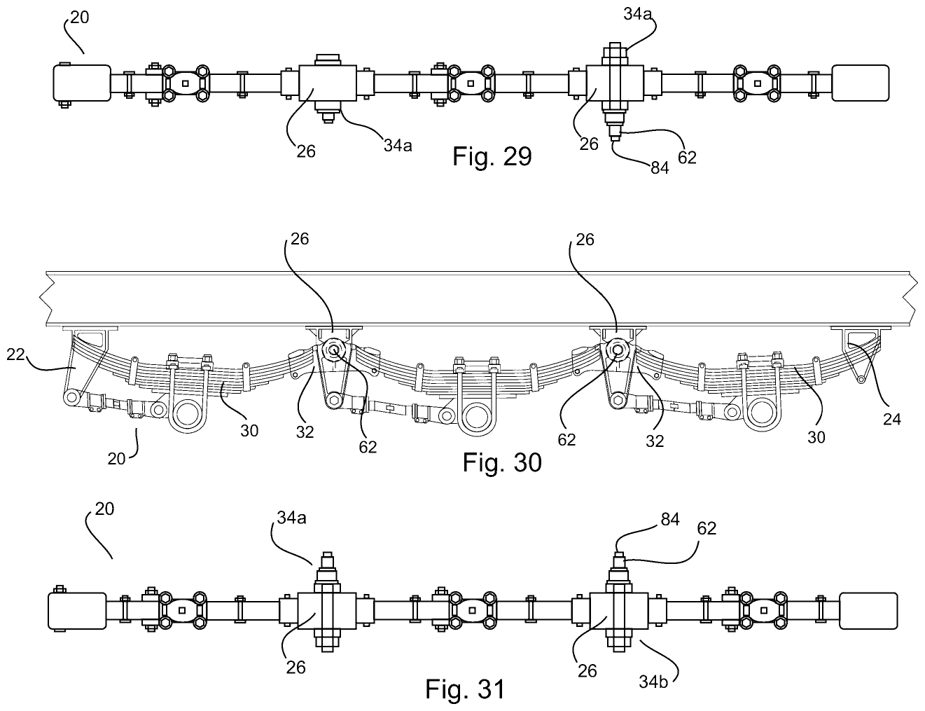

Referring now to FIGS. 29 to 32.

It was mentioned before that in accordance with particular embodiments of the invention, the suspension 20 may incorporate at least one low friction pivot joint 34 and/or at least one lower friction pivot joint 34.

For example, in a first arrangement of a third embodiment of the invention there may be provided suspension systems 20 incorporating (1) a lower friction pivot joint 34b comprising one load cell pin 62 surrounded by a bearing assembly 48 or (2) a low friction pivot joint 34b comprising one load cell pin 62 surrounded by a bearing 118 comprising greasable bushes 102 as shown in FIGS. 35, 36 and 38. Also, in this particular arrangement, the remaining pivot joint(s) 34a may be standard pivot joints of the type used in conventional suspension systems 20 of the prior art. This particular arrangement is shown in FIG. 29.

Further, in a first arrangement of a fourth embodiment of the invention there is provided a suspension 20 incorporating (1) a first lower friction pivot joint 34a comprising one load cell pin 62 surrounded by a bearing assembly 38 and (2) a second low friction pivot joint 34b comprising one load cell pin 62 that is surrounded by a bearing assembly 118 comprising greaseable bush 102 as shown in FIGS. 35, 36 and 38. This particular arrangement is shown in FIGS. 30 and 31.

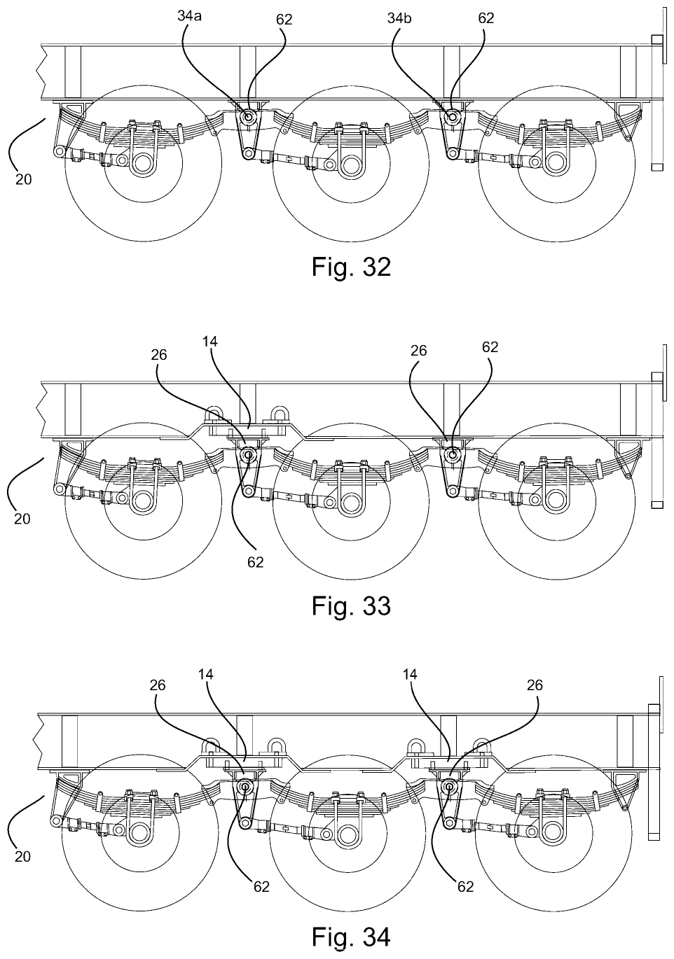

Furthermore, FIG. 32 shows a particular arrangement of a fifth embodiment of the invention. In this particular arrangement there is provided a suspension 20 incorporating a (1) first lower friction pivot joint 34a defined by a conventional pin used in the prior art for attaching the rocker 32 to the hanger 26 and (2) a second pivot joint 34b comprising one load cell pin 62. The pivot joint 34b may be either a low or a lower friction joint 34; alternatively, the pivot joint 34b may be standard pivot joints of the type used in conventional suspension systems 20 of the prior art.

Referring now to FIGS. 33 and 34.

FIGS. 33 and 34 show particular arrangements of suspension systems 20 attached to rear ends of semi-trailers 12 comprising load cells 14 being sandwiched between the lower surface of the semi-trailer 12 and hanger 26. In accordance with the sixth embodiments of the invention, the suspension 20 shown in FIG. 32 comprises lower friction pivot joints 34.

Referring now to FIGS. 35 and 36.

FIGS. 35 and 36 depict a particular arrangement of a bush 102 in accordance with the seventh embodiment of the invention. The bush 102 comprises a conical body 104 having an opening 106 traversing the body 104.

The conical body 104 comprises an inner end 108 and an outer end 110.

The inner end 108 comprises a smaller surface area than the outer end 110. The outer end 110 is adapted to receive a metal bearing 112 as is shown in FIG. 35. The metal bearing 112 comprises an inner end 113 located within the bush 102 and an outer end 115 being flush with the outer end 110 of the bush.

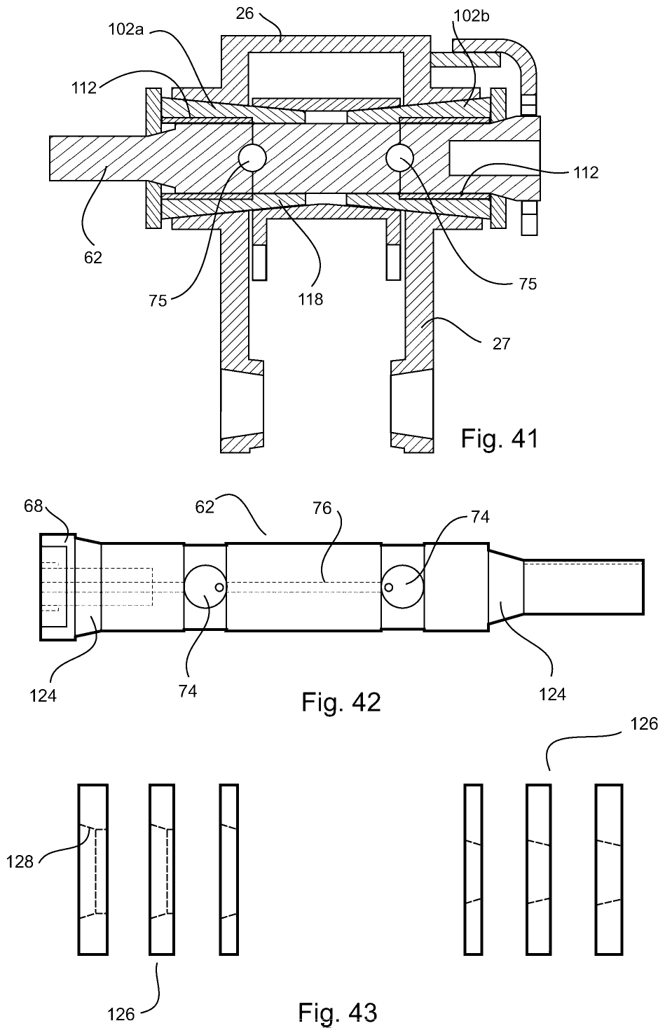

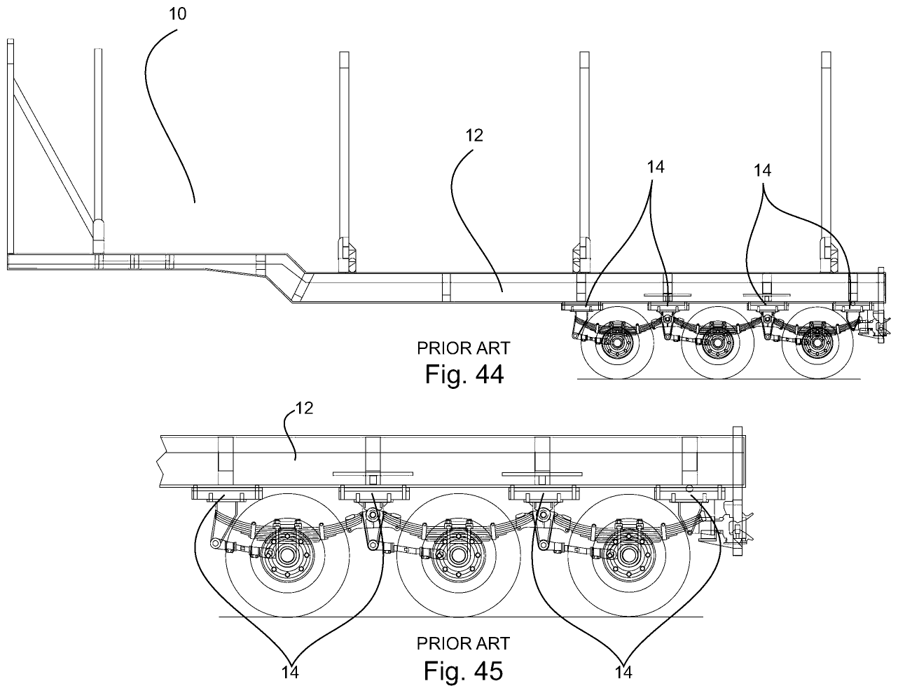

In accordance with a particular arrangement, the metal bearing 112 is configured in such a manner that, when a bush 102 is mounted on a load cell pin 62, the inner end 113 of each metal bearing 112 aligns with each of the shear plates 75 of the load cell pin 62 shown in FIG. 16. This can be appreciated in FIG. 41.

The fact that the inner ends 113 of the metal bearings 112 align with the shear plates increases accuracy of weight measurement of the load cell 62.

Further, the conical body 104 comprises one or more grooves 114 arranged in a spaced apart relationship with respect to each other around the outer surface of the conical body 104. In the particular arrangement shown in the figures, the grooves 114 extend partially from the inner end 108 towards the outer end 110 of the conical body 104. Each groove 114 has an open end at the inner end 108 of the conical body 104, and, each groove 114 extends parallel to the longitudinal axis of the conical body 14.

The fact that the bush 102 comprises the grooves 114 is particularly advantageous because it permits spreading of the grease around the outer periphery (the bearing surface) of the bush 102; also, the grooves permits discarding any excess lubrication such as grease through the open ends of the grooves 114. As mentioned before, the rockers 30 comprises means for providing lubrication to the joint between the rocker 20 and the hangers 26 to which the rockers 30 are pivotally attached. These type of bushes are referred to as greaseable bushes.

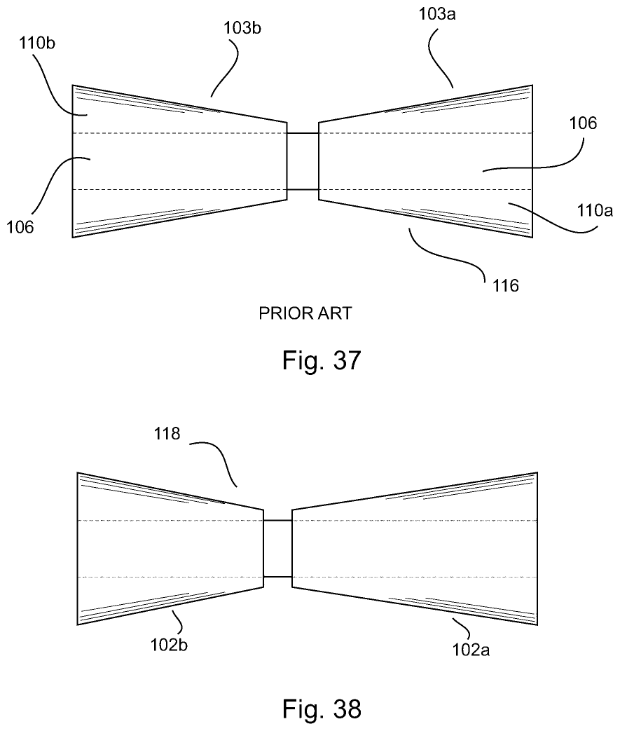

Referring now to FIGS. 37 and 38.

FIG. 37 shows a conventional bearing assembly 116 of the prior art defined by two bushes 103. The bearing assembly 116 is defined by two bushes 103 joined together through their inner ends 108 such that the openings 106 of the bushes 103 define a passage from the outer end 110a of the bush 103a to the outer end 110b of the bush 103b. The passage permits a pin (such as for example load cell pin 62) to traverse the bearing assembly 116 for pivotally attaching a rocker 32 of a suspension 20 to a hanger 26 for attachment to a trailer 12. Further, as shown in FIG. 37, the bearing assembly 116 comprises a pair of bushes 103 of equal length.

In contrast, the bearing assembly 118 in accordance with the eight embodiment of the invention shown in FIG. 38 comprises a pair of bushes 102 of different length. There is an inner bush 102a and an outer bush 102b when the bearing assembly 116 is mounted on a pin (such as a load cell pin 62) for defining the pivot joint 34. The outer bush 102b is the bush 102 that faces the outer side of the trailer 12 to which the suspension 20 is attached and the inner bush 102a is the bush 102 that faces the inner area under the trailer 12.

The particular arrangement of bearing assembly 118 shown in FIG. 38 comprises a bush 102a that is longer than the outer bush 102b. For example, a bearing assembly 118 for use in a pivot joint 34 in accordance with the present embodiments of the invention that requires being of a length 130 mm may include an inner bush 102a of a length of 67 mm or 68 mm and an inner bush 102b of a length of 63 mm or 62 mm, respectively.

In a particular arrangement of the eight embodiment of the invention, the bearing assembly 118 comprises a plurality of bushes 102 in accordance with the seventh embodiment of the invention comprising one or more grooves 114 arranged in a spaced apart relationship with respect to each other. In other arrangements, the bearing assembly 118 may comprise conventional bushes in accordance with the prior art.

The fact that the bearing assembly 118 in accordance with the eight embodiment of the invention comprises bushes 102 of different length is particularly advantageous because it facilities centralising the rocker 32 to the casting of the hanger 26 when pivotally attaching the rocker 32 to the hanger 26 via the pivot joint 34 defined by a pin (such as a load cell pin) and the bearing assembly 118.

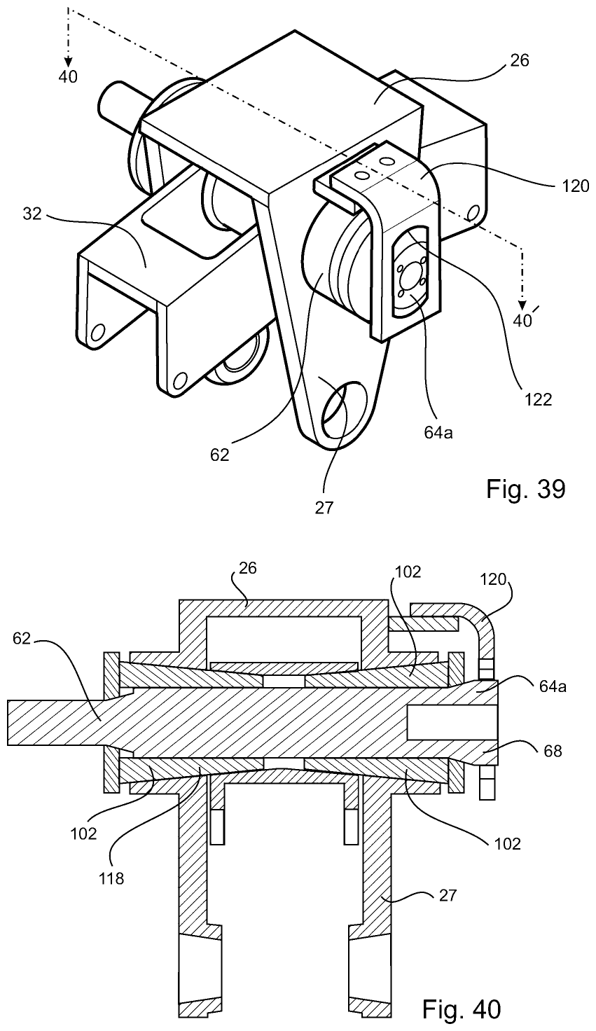

Referring now to FIGS. 39 to 41.

FIG. 39 depicts a second arrangement of a rocker 32 and hanger 26 assembly. The rocker 32 and hanger 26 assembly shown in FIG. 39 comprises a support cap 120 that is attached to the hanger and extends downward towards the end 64a of the load cell pin 62.

The support cap 120 comprises an opening 122 configured for receiving the stepped section 68 of the end 64a of the pin 62. The fact that the opening 122 is configured to receive the stepped section 68 is particular useful because it permits properly orientating (around the longitudinal axis of the load cell pin 62) of the load cell pin 62 during installation of the load cell pin 62. This is because the particular configuration of the opening 122 forcers the pin 62 to be installed exclusively in one particular angular orientation around the longitudinal axis of the pin 62.

FIG. 40 shows the rocker 32 and hanger 26 assembly shown in FIG. 39 including a pair of bushes 102. The inner ends 108 of each bush 102 face each other defining a bush assembly 118 for receiving, for example, the load cell pin 62.

In a particular arrangement, the bearing assembly 118 shown in FIG. 40 comprises a plurality of bushes 102 in accordance with the seventh embodiment of the invention comprising one or more grooves 114 arranged in a spaced apart relationship with respect to each other. In other arrangements, the bearing assembly 118 may comprise conventional bushes of the prior art.

Further, FIG. 41 shows a rocker 32 and hanger 26 assembly substantially identical to the rocker 32 and hanger 26 assembly of FIG. 40 except that the bush assembly 118 comprises bushes 102 as depicted in FIGS. 35 and 36. As shown in FIG. 41, the metal inserts 112 that extend into the opening 106 are configured in such a manner that the ends 113 of the bushes 102 align with the shear plates 75 of the load cell pin 62.

Moreover, FIG. 41 shows a third arrangement of a load cell pin 62 in accordance with the second embodiment of the invention. This particular arrangement of load cell 62 comprises tapered sections 124 adjacent the ends 64 of the load cell 62.

The tapered sections 124 are adapted to receive washers 126 incorporating openings having tapered inner surfaces 128. FIG. 43 shows several washers suited for different type of suspensions 20. The washers 126, once mounted onto the ends 64 of the load cell pin 62, maintain the load cells 62 inside the rocker 32 and hanger 26.

Modifications and variations as would be apparent to a skilled addressee are deemed to be within the scope of the present invention.

Further, it should be appreciated that the scope of the invention is not limited to the scope of the embodiments disclosed.

Throughout this specification, unless the context requires otherwise, the word “comprise” or variations such as “comprises” or “comprising”, will be understood to imply the inclusion of a stated integer or group of integers but not the exclusion of any other integer or group of integers.

1. A bearing assembly for a pivot joint that attaches a rocker to a hanger of a suspension, the bearing assembly comprising a core and a sleeve adapted to receive the core, the sleeve comprising outer sections and an inner section sandwiched between the outer sections wherein the inner section comprises at least one bearing having an inner surface in mating arrangement with an outer surface of the core, and an outer surface in mating arrangement with an inner surface of the rocker.

2. A bearing assembly according to claim 1 wherein the bearing comprises a spherical bearing.

3. A bearing assembly according to claim 1 or 2 wherein the bearing is attached to each inner side of the outer sections through a flexible joint.

4. A bearing assembly according to any one of the preceding claims wherein each outer section is configured as truncated conical sections with their end that has the smaller diameter being attached to the bearing through a flexible joint.

5. A bearing assembly according to any one of the preceding claims wherein there are a plurality of bearings sandwiched between the outer sections of the outer sleeve.

6. A bearing assembly according to claim 5 wherein the plurality of bearings are arranged in a spaced apart relationship with respect to each other.

7. A bearing assembly according to claim 1 wherein neighboring bearings are joined to each other through a flexible joint.

8. A bearing assembly according to any one of the preceding claims wherein the core comprises an outer sleeve and an inner rod being adapted to be inserted in the outer sleeve.

9. A bearing assembly according to any one of the preceding claims wherein the core comprises means for securing the inner rod within the outer sleeve.

10. A bearing assembly according to claim 8 wherein the outer sleeve and the inner rod comprise each one a disc perpendicularly attached thereto for sandwiching the sleeve of the bearing assembly between the discs when then sleeve of the bearing assembly is surrounding the core.

11. A pivot joint for pivotally attaching a rocker to a hanger of a suspension, the pivot joint comprising the bearing assembly in accordance with any one of claims 1 to 11.

12. A suspension for a semi-trailer, the suspension comprising at least two hangers and at least two rockers for attachment of ends of spring assemblies of the suspension, and at least two pivot joints in accordance with claim 11, wherein each rocker is pivotally attached to a hanger through one of the pivot joints.

13. A suspension according to claim 12 wherein the suspension comprises an overslung suspension.

14. A suspension according to claim 12 wherein the suspension comprises an underslung suspension.

15. A semi-trailer having a chassis and a tray for receiving a load, the semi-trailer comprising a pair of suspensions in accordance with any one of claims 12 to 14 attached to each side of the chassis through the hangers, wherein the semi-trailer further comprises a weighing system having a load cell sandwiched between a lower surface of each side of the chassis and one of the hangers, wherein at least one hanger comprises one of the pivot joints for attachment of one of the rockers.

16. A suspension according to claim 15 wherein the load cell is located frontward with respect to the point of load of the semi-trailer.

17. A suspension according to claim 15 or 16 wherein the chassis comprises a strong chassis.

18. A suspension according to any one claims 15 to 17 wherein the lower surface of each side of the chassis comprises an indentation for receiving the load cell.

19. A suspension according to any one claims 15 to 17 wherein the chassis comprises a flexible chassis, the load cell being located rearward from the point of load of the semi-trailer.

20. A suspension according to any one claims 15 to 19 wherein the weighing system comprises a pair of load cells attached to each side of the chassis.

21. A suspension according to any one claims 15 to 20 wherein the lower surface of each side of the chassis comprises two indentations, each indentation being adapted for receiving one of the load cells.

22. A pin for a pivot joint that attaches a rocker to a hanger of a suspension attached to a semi-trailer, the pin comprising a body having a first section, a second section and centre section located between the first and section sections, and at least one sensor means operatively attached to the body of the pin for detecting application of load to the chassis of the semi-trailer as well as measuring the load applied to the semi-trailer.

23. A pin according to claim 22 wherein the sensor means comprises at least one load cell operatively engaged to the body of the pin.

24. A pin according to claim 22 or 23 wherein the pin comprises at least one cavity defining a shear plate for receiving the load cell.

25. A pin according to any one of claims 22 to 24 wherein the pin is adapted to transfer signals between the load cell and the exterior of the pin.

26. A pin according to any one of claims 22 to 25 wherein the body of the pin comprises at least one first passage extending from the cavity to the exterior of the pin for operatively connecting the load cell contained in the cavity to the exterior of the pin.

27. A pin according to claim 26 wherein the passage comprises a wiring hole to allow passage of conductor means through the passage.

28. A pin according to any one claims 22 to 27 wherein the body of the pin is adapted to receive a resistor board operatively connected to the load cell.

29. A pin according to claim 28 wherein, a first end of the body of the pin comprises an aperture for receiving the resistor board.

30. A pin according to claim 28 or 29 wherein a second end of the body comprises an aperture for receiving the resistor board.

31. A pin according to any one of claims 22 to 30 wherein the body of the pin comprises pair of cavities arranged in a spaced apart relationship with respect to each other along the body of the pin.

32. A pin according to claim 31 wherein each cavity comprises indentations extending into the body of the pin.

33. A pin according to claims 31 to 32 wherein there are a pair of cavities on each side of the centre section of the pin.

34. A pin according to any one of claims 31 to 33 wherein each particular cavity has an opposite cavity located opposite to that particular cavity.

35. A pin according to any one of claims 31 to 34 wherein the cavities are operatively connected to each other via second passages.

36. A pin according to claim 35 wherein the second passages are operatively connected to the first passage.

37. A pin according to any one of claims 31 to 36 wherein each cavity comprises at least one load cell operatively engaged to the body of the pin.

38. A pin according to any one of claims 22 to 37 wherein one end of the body of the pin comprises a squared section to allow orientation of the pin via a support cap having an opening configured to receive the squared end.

39. A pin according to any one of claims 22 to 37 wherein body of the pin comprises at least one section of reduced radius defining at least one indentation extending into the periphery of the pin.

40. A pin according to claim 39 wherein the centre section of the body of the pin comprises the indentation.

41. A pin according to claim 39 or 40 wherein there are at least one two indentations arranged in a spaced apart relationship with respect to each other.

42. A pin according to any one of claims 39 to 41 wherein the indentations are arranged in such a manner that the indentations are located substantially at each end of the centre section of the pin.

43. A pin according to any one of claims 31 to 42 wherein a plurality of grooves are arranged in a spaced apart relationship with respect to each other, each groove surrounds the periphery of the load cell at a location where each cavity extends into the load cell pin.

44. A pin according to claim 43 wherein the load cell pin comprises a slot extending longitudinally along the longitudinal axis of the load cell pin and between the grooves.

45. A pin according to any one of claims 22 to 44 wherein the load cell comprises tapered sections adjacent each end of the load cell.

46. A bearing assembly for a pivot joint that attaches a rocker to a hanger of a suspension, the bearing assembly comprising the pin in accordance with claim 22 and a sleeve adapted to receive the pin, the sleeve comprising outer sections and an inner section sandwiched between the outer sections wherein the inner section comprises at least one bearing having an inner surface in mating arrangement with an outer surface of the pin, and an outer surface in mating arrangement with an inner surface of the rocker.

47. A pivot joint for pivotally attaching a rocker to a hanger of a suspension, the pivot joint comprising the bearing assembly in accordance with claim 46.

48. A suspension for a semi-trailer, the suspension comprising at least one hanger and at least one rocker for attachment of ends of spring assemblies of the suspension, and at least two pivot joints in accordance with the seventh aspect of the invention, wherein each rocker is pivotally attached to a hanger through one of the pivot joints.

49. A suspension according to claim 48 wherein the rocker comprises means for providing lubrication to the pivot joint between the rocker and the hangers.

50. A suspension according to claim 48 or 39 wherein the suspension comprises an overslung suspension.

51. A suspension according to claim 48 or 39 wherein the suspension comprises an underslung suspension.

52. A suspension according to any one claims 48 to 51 wherein the rocker comprises means for supporting the load cell pin within the rocker.

53. A suspension according to claim 52 wherein the means for supporting comprises a tapered ring on each side of the rocker.

54. A suspension according to claim 52 wherein the means for supporting comprises at least one support cap on one side of the rocker.

55. A pivot joint for pivotally attaching a rocker to a hanger of a suspension, the pivot joint comprising a load cell pin in accordance with claim 22 and a bearing assembly comprising a plurality of bushes adapted to surround the load cell pin.

56. A pivot joint according to claim 55 wherein each bush comprises a body having an inner end and an outer end; the surface areas of the outer end being greater than the surface area of the inner end.

57. A pivot joint according to claim 55 or 56 wherein the bearing assembly is defined by arranging the bushes in a spaced apart relationship with respect to each other with the inner ends of each bush facing each other.

58. A pivot joint according to any one of claims 55 to 57 wherein each of the bushes comprises one or more grooves arranged in a spaced apart relationship with respect to each other around the outer surface of the body of the bush.

59. A pivot joint according to claim 58 wherein the grooves extend partially from an inner end of the body of the bush towards an outer end of the body of the bush.

60. A pivot joint according to claim 58 or 59 wherein each groove comprises an open end located at the inner end of the bush.

61. A pivot joint according to any one of claims 55 to 60 wherein each bush comprises a metal bearing extending into the bush from the inner end.

62. A pivot joint according to claim 61 wherein the metal bearing is configured in such a manner that an end of the metal bearing aligns with the shear plate of the load cell pin.

63. A suspension for a semi-trailer, the suspension comprising at least one hanger and at least one rocker for attachment of ends of spring assemblies of the suspension, and at least one pivot joint in accordance with claim 55, wherein the rocker is pivotally attached to a hanger through one of the pivot joints.

64. A semi-trailer having a chassis and a tray for receiving a load, the semi-trailer comprising a pair of suspensions, each suspension comprising at least two hangers and at least two rockers for attachment of ends of spring assemblies of the suspension, and at least two pivot joints, wherein each rocker is pivotally attached to a hanger through one of the pivot joints, each suspension being attached to each side of the chassis through a plurality of hangers, wherein the semi-trailer further comprises a weighing system having a load cell sandwiched between a lower surface of each side of the chassis and a first hanger of the plurality of hangers, wherein at least one second hanger of the plurality of hangers comprises a pivot joint in accordance with either claim 55 or claim 11 for pivotally attaching one of the rockers to the second hanger.

65. A semi-trailer according to claim 64 wherein the first pivot joint comprises a pivot joint in accordance with either claim 55 or claim 11 for pivotally attaching one of the rockers to the first hanger.

66. A semi-trailer according to claim 64 or 65 wherein each load cell is located frontward with respect to the point of load of the semi-trailer.

67. A semi-trailer according to any one of claims 64 to 66 wherein the chassis comprises a strong chassis.

68. A semi-trailer according to any one of claims 64 to 67 wherein the lower surface of each side of the chassis comprises an indentation for receiving the load cell.

69. A semi-trailer according to any one of claims 64 to 66 wherein the chassis comprises a flexible chassis, the load cell being located rearward from the point of load of the semi-trailer.

70. A semi-trailer according to any one of claims 64 to 69 wherein the weighing system comprises a pair of load cells attached to each side of the chassis.

71. A semi-trailer according to any one of claims 64 to 70 wherein the lower surface of each side of the chassis comprises two indentations, each indentation being adapted for receiving one of the load cells.

72. A semi-trailer having a chassis and a tray for receiving a load, the semi-trailer comprising a pair of suspensions in accordance with claim 63 attached to each side of the chassis through a plurality of hangers, wherein at least one another hanger comprises a pivot joint in accordance with claim 55 and/or claim 11 for pivotally attaching one of the rockers to the first hanger.

73. A bush for defining a bearing assembly for a pivot joint joining together a rocker and a hanger of a suspension for a semi-trailer, wherein the bush comprises one or more grooves arranged in a spaced apart relationship with respect to each other around the outer surface of the body of the bush.

74. A bush according to claim 73 wherein the grooves extend partially from an inner end of the body of the bush towards an outer end of the body of the bush.

75. A bush according to claim 73 or 74 wherein each groove comprises an open end located at the inner end of the bush.

76. A bush according to any one of claims 73 to 75 wherein each bush comprises a metal bearing extending into the bush from the inner end.

77. A bush according to claim 76 wherein the metal bearing is configured in such a manner that an end of the metal bearing aligns with the shear plate of the load cell pin.

78. A bearing assembly comprising a plurality of bushes in accordance with the claim 73, the bushes being arranged in a spaced apart relationship with respect to each other with inner ends of each bush facing each other.

79. A bush according to claim 78 wherein each bush comprises a body having an inner and an outer end; the surface areas of the outer end being greater than the surface area of the inner end.

80. A bush according to claim 78 or 79 wherein the body of the bush comprises a conical bush.

81. A bearing assembly comprising an inner bush and an outer bush, the inner and outer bushes being arranged in a spaced apart relationship with respect to each other with inner ends of each bush facing each other, wherein the bodies of the inner bush and outer bush differ in length with respect to each other.

82. A bearing assembly according to claim 81 wherein the inner bush is of greater length than the outer bush.

83. A bearing assembly according to claim 81 or 82 wherein each of the inner bush and the outer bush comprises a bush in accordance with claim 73.
